(19) United States
(12) Patent Application Publication
(10) Pub. No.: US 2008/0187144 A1
(43) Pub. Date: Aug. 7, 2008

(54) Multichannel Audio Compression and Decompression Method Using Virtual Source Location Information

(76) Inventors: Jeong II Seo, Daejeon (KR); Seung Kwon Beack, Daejeon (KR); In Seon Jang, Gyeonggi (KR); Kyeong Ok Kang, Daejeon (KR); Jin Woo Hong, Daejeon (KR); Min Soo Hahn, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/817,808

(22) PCT Filed: Mar. 14, 2006
(86) PCT No.: PCT/KR06/00916

§ 371 Date: Sep. 5, 2007

(30) Foreign Application Priority Data
Mar. 14, 2005 (KR) 10-2005-0021104
Mar. 14, 2006 (KR) 10-2006-0023545

(51) Int. Cl. H04R 29/00

(52) U.S. Cl. 381/56

(57) ABSTRACT

A method for compressing and decompressing a multi-channel signal using virtual source location information (VSLI) on a semicircular plane is provided. VSLI, rather than inter channel level difference (ICLD), is used as spatial cue information, thereby minimizing loss caused by quantization of spatial cue information, improving sound quality of a decompressed audio signal, and reproducing an excellent audio signal by reducing distortion upon decompression of an original signal at a decoder spectrum.

### TECHNICAL FIELD

The present invention relates to compression and decompression of a multi-channel audio signal, and more particularly, to a method for compressing and decompressing a multi-channel audio signal based on virtual source location information (VSLI) on a semicircular plane.

### BACKGROUND ART

In a conventional binaural cue coding method, an inter-channel level difference (ICLD) is generally used as spatial cue information in compressing spectral information of a multi-channel audio signal. However, the ICLD is subject to a quantization process before being transmitted. Since the quantization process assigns a limited number of bits, resolution is limited. Accordingly, such information loss in the ICLD deteriorates a decompressed audio signal.

### DISCLOSURE

### Technical Problem

The present invention is directed to a method for representing, compressing and decompressing a multi-channel audio signal using virtual source location information (VSLI) represented on a limited semicircular plane rather than an ICLD, as a spatial cue parameter, thereby minimizing loss caused by quantization of spatial cue information and improving the sound quality of a decompressed audio signal.

The present invention is also directed to a method for compressing a multi-channel audio signal in which only N−1 pieces of virtual source location information are estimated and transmitted according to a location of a global vector in representing and compressing N multi-channel audio signals using a down-mixed audio signal and virtual source location information and transmitting them to a decoder, thereby reducing an amount of transmitted information.

### TECHNICAL SOLUTION

One aspect of the present invention provides a method for estimating virtual source location information (VSLI) which is used as spatial cue information in compressing a multi-channel audio signal, the method comprising the steps of: (i) virtually assigning channels of the multi-channel audio signal on a semicircular plane; (ii) converting the multi-channel audio signal into a signal in a frequency domain; (iii) dividing the signal in the frequency domain into a plurality of sub-bands and calculating a signal size of each channel in each sub-band; (iv) estimating a global vector represented on the semicircular plane from the calculated signal size of each channel in each sub-band and virtual location information of each virtually assigned channel signal; and (v) determining whether an angle of the global vector in each sub- band is greater than zero, and estimating local vectors in a first set when the angle of the global vector is greater than zero and in a second set when the angle of the global vector is smaller than zero.

Another aspect of the present invention provides a method for compressing a multi-channel audio signal based on virtual source location information (VSLI), the method comprising the steps of: obtaining angle information of the global vector and the plurality of local vectors which indicate the virtual source location information estimated by performing the above-described method; quantizing the angle information of the global vector and the local vectors; down-mixing and encoding the input multi-channel audio signal; and multiplexing the encoded, down-mixed audio signal with the quantized angle information of the vectors to finally generate a compressed multi-channel audio signal.

Yet another aspect of the present invention provides a method for decompressing a compressed multi-channel audio signal represented by virtual source location information (VSLI) and an encoded down-mixed audio signal based on spatial cue information, the method comprising the steps of: (i) predicting inverse panning angle information from the VSLI using a constant power panning rule; (ii) obtaining an estimated power component of each channel in each sub-band using the predicted inverse panning angle information; and (iii) finally decompressing a signal of each channel in each sub-band using the estimated power component of each channel and the down-mixed audio signal.

### ADVANTAGEOUS EFFECTS

In the method for compressing a multi-channel signal using virtual source location information on a semicircular plane according to the present invention, spatial cue information is represented using virtual sound location information (VSLI), thereby minimizing loss caused by quantization of spatial cue information and improving the sound quality of a decompressed audio signal.

### DESCRIPTION OF DRAWINGS

FIG. 1 schematically illustrates the configuration of a multi-channel audio encoder that the present invention may be employed;

FIG. 2 is a flowchart illustrating a process of estimating virtual sound location information (VSLI) of a multi-channel audio signal according to an exemplary embodiment of the present invention;

FIG. 3 illustrates an example in which respective channels of a multi-channel audio signal are virtually assigned on a semicircular plane structure according to an exemplary embodiment of the present invention;

FIG. 4 illustrates an example of local vectors estimated in respective sections of a semicircular plane structure shown in FIG. 3; and

FIG. 5 is a flowchart illustrating a process of decoding a multi-channel audio signal that has been compressed and represented based on VSLI according to an exemplary embodiment of the present invention.

### MODE FOR INVENTION

Hereinafter, exemplary embodiments of the present invention will be described in detail. However, the present invention is not limited to the exemplary embodiments disclosed below, but can be implemented in various forms. Therefore, the present exemplary embodiments are provided for complete disclosure of the present invention and to fully convey the scope of the present invention to those of ordinary skill in the art.

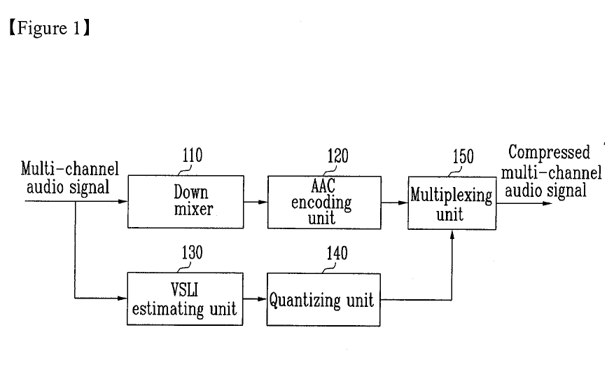

FIG. 1 schematically illustrates the configuration of a multi-channel audio encoder according to the present invention. Referring to FIG. 1, the multi-channel audio encoder includes a down mixer 110 for down-mixing an input multi-channel audio signal to generate a down-mixed audio signal, an advanced audio coding (AAC) encoding unit 120 for encoding the down-mixed audio signal, a virtual source location information (VSLI) estimating unit 130 for estimating virtual source location information from the multi-channel audio signal, a quantizing unit 140 for quantizing the VSLI, and a multiplexing unit 150 for multiplexing the down-mixed audio signal encoded by the AAC encoding unit 120 with the VSLI quantized by the quantizing unit 140 to finally generate a compressed multi-channel audio signal.

In the present invention, the virtual source location information (VSLI) is represented by an azimuth angle between virtual source location vectors on a semicircular plane, which are estimated from signal magnitude of respective channels in a multi-channel audio signal, and a center channel. Since (N−1) pieces of virtual source location information are used for N multi-channel audio signals, an amount of the virtual source location information is the same as an inter-channel level difference (ICLD).

In an exemplary embodiment of the present invention, the virtual sound location vectors include a global vector Gv_{b}, left and right half-plane vectors LHv_{b}and RHv_{b}, and left and right subsequent vectors LSv_{b} and RSv_{b}. Angles between the respective vectors and the center channel are represented by Ga_{b}, LHa_{b}, RHa_{b}, LSa_{b} and RSa_{b}, respectively.

In the present invention, the channels of the multi-channel audio signal are virtually assigned on the semicircular plane, and the virtual source location vectors represented on the semicircular plane are estimated from signal magnitude of the respective channels. A set of the estimated virtual source location vectors varies with the location of the global vector. Information about an angle between each estimated virtual source location vector and the center channel will be transmitted as the virtual source location information together with the down-mixed audio signal to the decoder.

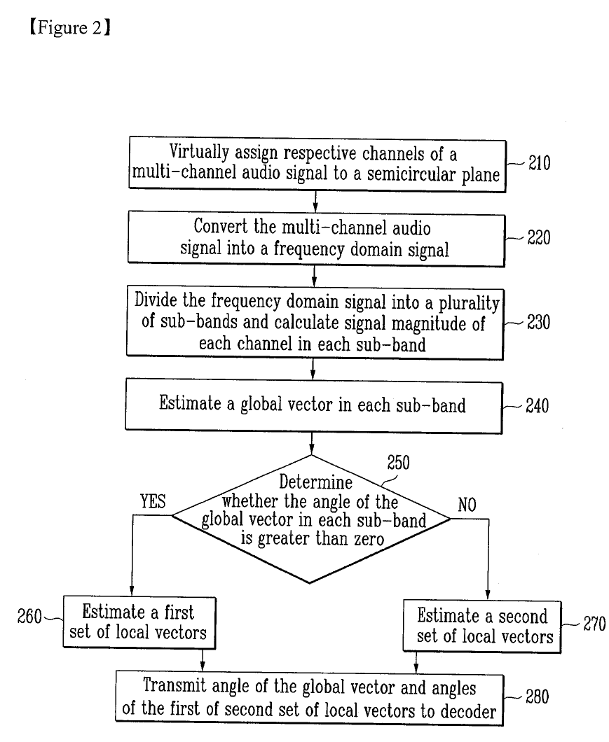

FIG. 2 is a flowchart illustrating a process of estimating VSLI of a multi-channel audio signal according to an exemplary embodiment of the present invention.

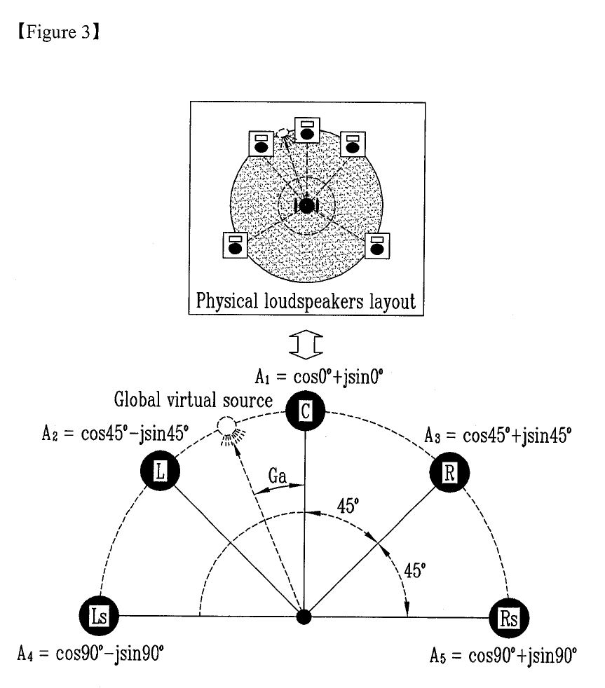

In step 210, respective channels of an input multi-channel audio signal are virtually assigned to a two-dimensional semicircular plane. FIG. 3 shows an example of five channels of C, L, R, Ls and Rs of a multi-channel audio signal assigned on the semicircular plane at 45° intervals, and a global vector which is estimated from the channels, according to an exemplary embodiment of the present invention.

In step 220, the multi-channel audio signal is converted into a signal in a frequency domain. In step 230, the signal in the frequency domain is divided into a plurality of sub-bands and the signal magnitude of each channel in each sub-band is calculated using the following Equation 1:

$${M}_{ch , b} = {\sum }_{n = {B}_{b}}^{{B}_{b + 1} - 1} \vert {S}_{ch , n} \vert , \qquad Equation 1$$

where S_{ch,n} denotes a frequency coefficient of the ch-th channel. In an embodiment of the present invention, ch denotes one of a center channel (C), left channel (L), right channel (R), left surround channel (Ls), and right surround channel (Rs). B_{b} and B_{b+1}−1 denote frequency indexes corresponding to upper and lower boundaries of the sub-band B_{b}, respectively.

In step 240, a global vector represented on the semicircular plane assigned the channels is estimated from the signal magnitude of each channel in each sub-band. In the sub-band b, a global vector Gv_{b} is estimated using the following Equation 2:

Gᵥ_{_{b}}=A₁sM_{c,b}+A₂sM_{L,b}+A₃sM_{R,b}+A₄sM_{Ls,b}+A₅sM_{Rs,b}, (2)

where Aᵢ denotes virtual location information of each channel signal assigned on the semicircular plane. It may be mapping information of each channel that is assigned on the semicircular plane in step 210. In the embodiment shown in FIG. 3, the virtual location information may be defined as A₁=cos0°+jsin0°, A₂=cos45°-jsin45°, A₃=cos45°+jsin45°, A₄=cos90°-jsin90°, and A₅=cos90°+jsin90° in order of the center, left, right, left surround, and right surround channel signals.

In step 250, it is determined whether the angle Ga_{b} of the global vector in each sub-band is greater than zero. In step 260, if the angle of the global vector is greater than zero, a first set of local vectors are estimated. In step 270, if the angle of the global vector is smaller than zero, a second set of local vectors are estimated. In an embodiment, the first set of local vectors includes LHv_{b}, LSv_{b}, and RSv_{b}, and the second set of local vectors includes RHa_{b}, RSa_{b}, and LSa_{b}.

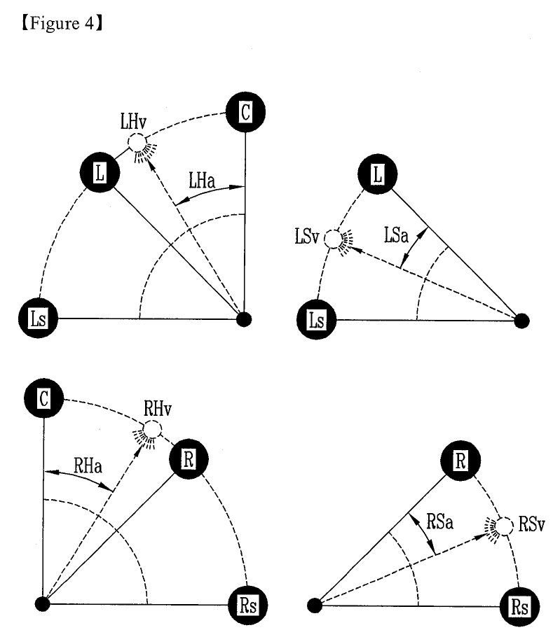

Local vectors for sections of the semicircular plane are estimated using the following Equations 3. An embodiment thereof is shown in FIG. 4.

LHv_{b}=A₁×M_{C,b}+A₂×M_{L,b}+A₄×M_{Ls,b}

RHv_{b}=A₁×M_{C,b}+A₃×M_{R,b}+A₅×M_{Rs,b},

LSv_{b}=A₂×M_{L,b}+A₄×M_{Ls,b}, and

RSv_{b}=A₃×M_{R,b}+A₅×M_{Rs,b}. (3)

In step 280, the angle of the global vector and the angles of the local vectors estimated in step 260 or 270 are transmitted as the VSLI to the decoder. That is, if the angle Ga_{b} of the global vector is smaller than zero, {Ga_{b}, RHa_{b}, RSa_{b}, LSa_{b}} is transmitted, and otherwise, {Ga_{b}, LHa_{b}, LSa_{b}, RSa_{b}} is transmitted.

In this manner, according to the present invention, it can be seen that the spatial cue information for N multi-channel audio signals can be represented by N−1 pieces of virtual source location information.

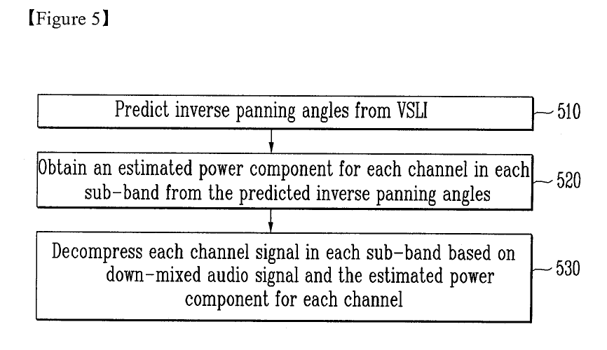

FIG. 5 is a flowchart illustrating a process of decoding a multi-channel audio signal that has been compressed and represented based on VSLI according to an exemplary embodiment of the present invention. The decoder estimates vector information of original sound from virtual source location information received together with the encoded down-mixed audio signal. The sound vector is represented by its magnitude and angle. The vector angle can be obtained from the received VSLI, and the vector magnitude can be obtained from the received down-mixed audio signal.

Specifically, as shown in FIG. 5, an inverse panning angle is predicted from the VSLI using a constant power panning (CPP) rule (S510). In this case, a method for predicting the other inverse panning angles depends on the angle Ga_{b} of the global vector. The inverse panning angle is predicted using the following Equations 4:

$$if {Ga}_{b} \geq 0 , \\ {θ}_{1} = ( \frac{{Ga}_{b} - {LHa}_{b}}{{RSa}_{b} - {LHa}_{b}} ) \times \frac{π}{2} , \\ {θ}_{2} = ( \frac{{LHa}_{b} - {LSa}_{b}}{0 - {LSa}_{b}} ) \times \frac{π}{2} \\ {θ}_{3} = ( \frac{{LSa}_{b} + π / 2}{- π / 4 + π / 2} ) \times \frac{π}{2} , \\ {θ}_{4} = ( \frac{{RSa}_{b} - π / 2}{π / 4 - π / 2} ) \times \frac{π}{2} \\ and , if {Ga}_{b} < 0 , \\ {θ}_{1} = ( \frac{{Ga}_{b} - {RHa}_{b}}{{LSa}_{b} - {RHa}_{b}} ) \times \frac{π}{2} , \\ {θ}_{2} = ( \frac{{RHa}_{b} - {RSa}_{b}}{0 - {RSa}_{b}} ) \times \frac{π}{2} \\ {θ}_{3} = ( \frac{{RSa}_{b} - π / 2}{π / 4 - π / 2} ) \times \frac{π}{2} , \\ {θ}_{4} = ( \frac{{LSa}_{b} + π / 2}{- π / 4 + π / 2} ) \times \frac{π}{2} \qquad Equations 4$$

In step 520, an estimated power component for each channel in the sub-band is obtained from the predicted inverse panning angle. The estimated power component for each channel is obtained using the following Equations 5:

if Ga_{b}≧0,

F_{C,b}=cos(θ₁) sin(θ₂),

F_{L,b}=cos(θ₁)cos(θ₂) sin(θ₃),

F_{Ls,b}=COS(θ₁) cos(θ₂) cos(θ₃),

F_{R,b}=sin(θ₁) sin(θ₄), and

F_{Rs,b}=sin(θ₁) cos(θ₄); and

if Ga_{b}<0,

F_{C,b}=cos(θ₁) sin(θ₂),

F_{L,b}=sin(θ₁) sin(θ₄),

F_{Ls,b}=sin(θ₁) cos(θ₄),

F_{R,b}=cos(θ₁) cos(θ₂) sin(θ₃), and

F_{Rs,b}=COS(θ₁) cos(θ₂) cos(θ₃). (5)

In step 530, each channel signal in each sub-band can be finally decompressed based on the down-mixed audio signal and the estimated power component for each channel according to the following equation:

U_{ch,k}=F_{ch,b}S′ₖ, B_{b}≦k≦B_{b+1}−1 (6)

where S′ₖ denotes a frequency component coefficient of the received down-mixed signal, and U_{ch,k} denotes the decompressed audio signal.

The present invention described above may be provided as one or more computer programs which are implemented on one or more computer-readable mediums. The mediums may include a floppy disc, a hard disc, a CD-ROM, a flash memory card, a programmable read only memory (PROM), a random access memory (RAM), a read only memory (ROM), and a magnetic tape. In general, the computer program may be written in any programming language, such as C, C++, and JAVA.

While the invention has been shown and described with reference to certain exemplary embodiments thereof, it will be understood by those skilled in the art that various changes in form and details may be made therein without departing from the spirit and scope of the invention as defined by the appended claims.

1. A method for estimating virtual source location information (VSLI) that is used as spatial cue information in compressing a multi-channel audio signal, the method comprising the steps of:
(i) virtually assigning each channel of the multi-channel audio signal to a semicircular plane;
(ii) converting the multi-channel audio signal into a frequency domain signal;
(iii) dividing the frequency domain signal into a plurality of sub-bands and calculating signal magnitude of each channel in each sub-band;
(iv) for each sub-band, estimating a global vector represented on the semicircular plane from the calculated signal magnitude of each channel in each sub-band and virtual location information of each virtually assigned channel signal; and
(v) for each sub-band, determining whether an angle of the global vector in the sub-band is greater than zero and estimating a first set of local vectors when the angle of the global vector is greater than zero and estimating a second set of local vectors when the angle of the global vector is smaller than zero.

2. The method of claim 1, wherein step (iii) comprises calculating the signal magnitude of each channel in each sub-band using the following equation:
$${M}_{ch , b} = {\sum }_{n = {B}_{b}}^{{B}_{b + 1} - 1} \vert {S}_{ch , n} \vert ,$$
where S_{ch,n} denotes a frequency coefficient of the ch-th channel, ch denotes one of a center channel (C), left channel (L), right channel (R), left surround channel (Ls), and right surround channel (Rs), and B_{b} and B_{b+1}−1 denote frequency indexes corresponding to upper and lower boundaries of the sub- band B_{b}, respectively.

3. The method of claim 2, wherein step (iv) comprises estimating the global vector for each sub-band using the following equation:
Gᵥ_{_{b}}=A₁sM_{c,b}+A₂sM_{L,b}+A₃sM_{R,b}+A₄sM_{Ls,b}+A₅ SM_{Rsb},
where A₁ denotes virtual location information of the center channel, A₂ denotes virtual location information of the left channel, A₃ denotes virtual location information of the right channel, A₄ denotes virtual location information of the left surround channel, and A₅ denotes virtual location information of the right surround channel.

4. The method of claim 3, wherein A₁=cos0°+jsin0°, A₂=cos45°-jsin45°, A₃=cos45°+jsin45°, A₄=cos90°-jsin90°, and A₅=cos90°+jsin90°.

5. The method of claim 1, wherein in step (v), the first set of local vectors includes a right half-plane vector RHv_{b}, a right subsequent vector RSv_{b} and a left subsequent vector LSv_{b}, and the second set of local vectors includes a left half-plane vector LHv_{b}, a left subsequent vector LSv_{b} and a right subsequent vector RSV_{b}.

6. The method of claim 5, wherein in step (v), the right half-plane vector RHv_{b} is estimated using the signal magnitude of center, right, and right surround channels calculated in step (iii); the right subsequent vector RSv_{b} is estimated using signal magnitude of right and right surround channels calculated in step (iii); the left half-plane vector LHv_{b} is estimated using signal magnitude of the center, left and left surround channels calculated in step (iii); and the left subsequent vector LSV_{b} is estimated using signal magnitude of left and left surround channels calculated in step (iii).

7. The method of claim 6, wherein the right half-plane vector RHv_{b}, the right subsequent vector RSv_{b}, the left half-plane vector LHv_{b} and the left subsequent vector LSv_{b} are estimated using the following equations:
LHv_{b}=A₁×M_{C,b+A}₂×M_{L,b}+A₄×M_{Ls,b},
RHv_{b}=A₁×M_{C,b}+A₃×M_{R,b}+A₅×M_{Rs,b},
LSv_{b}=A₂×M_{L,b}+A₄×M_{Ls,b}, and
RSv_{b}=A₃×M_{R,b}+A₅×M_{Rs,b}.

8. The method of claim 5, wherein when the angle of the global vector Ga_{b} is greater than zero, angle information of the global vector and the first set of local vectors is transmitted to a decoder, and otherwise, angle information of the global vector and the second set of local vectors is transmitted to the decoder.

9. A method for compressing a multi-channel audio signal based on virtual source location information (VSLI), the method comprising the steps of:
obtaining angle information of a global vector and a plurality of local vectors which represent the virtual source location information estimated by performing the method of any one of claims 1 to 7;
quantizing the angle information of the global vector and the local vectors;
down-mixing and encoding the input multi-channel audio signal; and
multiplexing the encoded, down-mixed audio signal with the quantized angle information of the vectors to finally generate a compressed multi-channel audio signal.

10. A method for decompressing a compressed multi-channel audio signal represented by virtual source location information (VSLI) and an encoded down-mixed audio signal based on spatial cue information, the method comprising the steps of:
(i) predicting inverse panning angle information from the VSLI using a constant power panning nile;
(ii) obtaining an estimated power component of each channel in each sub-band using the predicted inverse panning angle information; and
(iii) finally decompressing a signal of each channel in each sub-band using the estimated power component of each channel and the down-mixed audio signal.

11. The method of claim 10, wherein, in step (i), the prediction scheme of the inverse panning angle information differ according to the angle information of the global vector in the virtual source location information.

12. The method of claim 10, wherein step (i) includes predicting inverse panning angles θ₁, θ₂, θ₃ and θ₄ from the global vector angle Ga_{b}, the left half-plane vector angle LHa_{b}, the left subsequent vector angle LSa_{b} and right subsequent vector angle RSa_{b} in the virtual source location information when the global vector angle Ga_{b} in the virtual source location information is greater than zero, and from the global vector angle Ga_{b}, right half-plane vector angle RHa_{b}, right subsequent vector angle RSa_{b} and left subsequent vector angle LSa_{b} in the virtual source location information when the global vector angle Ga_{b} is smaller than zero.

13. The method of claim 11, wherein in step (i), the inverse panning angles θ₁, θ₂, θ₃, and θ₄ are estimated using the following equations:
if Ga_{b}≧0,
$${θ}_{1} = ( \frac{{Ga}_{b} - {RHa}_{b}}{{LSa}_{b} - {RHa}_{b}} ) \times \frac{π}{2} , \\ {θ}_{2} = ( \frac{{RHa}_{b} - {RSa}_{b}}{0 - {RSa}_{b}} ) \times \frac{π}{2}$$
$${θ}_{3} = ( \frac{{RSa}_{b} - π / 2}{π / 4 - π / 2} ) \times \frac{π}{2} , \\ {θ}_{4} = ( \frac{{LSa}_{b} + π / 2}{- π / 4 + π / 2} ) \times \frac{π}{2}$$
and, if Ga_{b}<0,
$${θ}_{1} = ( \frac{{Ga}_{b} - {LHa}_{b}}{{RSa}_{b} - {LHa}_{b}} ) \times \frac{π}{2} , \\ {θ}_{2} = ( \frac{{LHa}_{b} - {LSa}_{b}}{0 - {LSa}_{b}} ) \times \frac{π}{2}$$
$${θ}_{3} = ( \frac{{LSa}_{b} + π / 2}{- π / 4 + π / 2} ) \times \frac{π}{2} , \\ {θ}_{4} = ( \frac{{RSa}_{b} - π / 2}{π / 4 - π / 2} ) \times \frac{π}{2}$$

14. The method of claim 13, wherein step (ii) comprises obtaining the estimated power component of each channel in each sub-band using the following equations:
if Ga_{b}≧0,
F_{C,b}=cos(θ₁) sin(θ₂),
F_{L,b}=cos(θ₁) cos(θ₂) sin(θ₃),
F_{Ls,b}=cos(θ₁) cos(θ₂) cos(θ₃),
F_{R,b}=sin(θ₁) sin(θ₄), and
F_{Rs,b}=sin(θ₁) cos(θ₄); and
if Ga_{b}<0,
F_{C,b}=cos(θ₁) sin(θ₂),
F_{L,b}=sin(θ₁) sin(θ₄),
F_{Ls,b}=sin(θ₁) cos(θ₄),
F_{R,b=cos(θ}₁) cos(θ₂) sin(θ₃), and
F_{Rs,b}=cos(θ₁) cos(θ₂) cos(θ₃).

15. The method of claim 14, wherein step (iii) includes decompressing a signal of each channel in each sub-band using the following equation:
U_{ch,k}=F_{ch,b}S′ₖ, B_{b}≦k≦B_{b+1}−1,
where S′ₖ denotes a frequency component coefficient of a received down-mixed signal, and U_{ch,k} denotes a decompressed audio signal.

16. A computer-readable medium having a computer program recorded thereon for performing the method of claim 9.

17. A computer-readable medium having a computer program recorded thereon for performing the method of any one of claims 10 to 15.
